(19) United States
(12) Patent Application Publication
(10) Pub. No.: US 2008/0005047 A1
(43) Pub. Date: Jan. 3, 2008

(54) SCENARIO-BASED SEARCH

(75) Inventors: Gary W. Flake, Bellevue, WA (US); Joshua T. Goodman, Redmond, WA (US); Xuedong D. Huang, Bellevue, WA (US); Bradly A. Brunell, Medina, WA (US); William H. Gates, Medina, WA (US); Ramez Naam, Seattle, WA (US); Eric J. Horvitz, Kirkland, WA (US); Eric D. Brill, Redmond, WA (US); Alexander G. Gounares, Kirkland, WA (US); Oliver Hurst-Hiller, New York, NY (US); Trenholme J. Griffin, Bainbridge Island, WA (US); Susan T. Dumais, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/427,686

(22) Filed: Jun. 29, 2006

(51) Int. Cl. G06N 5/04

(52) U.S. Cl. 706/12

(57) ABSTRACT

The innovation provides for a computer search to become an action that has direct nexus to an inferred (or determined) goal of an individual. The goal can be inferred or determined from any number of context/state factors. The innovation can query a user to determine user context and state factors by which a goal, objective or intent can be automatically established. The innovation can also utilize machine learning/reasoning to establish the goal of a user based upon historical, statistical and/or other probabilistic analysis. Still further, the innovation can monitor a user's context and state thereafter dynamically journaling and logging the criterion by which the user's objective(s) can be established. Once a goal is established, a goal-based search can be automatically conducted thereafter prompting for an action based upon a subset of the search results.

### CROSS-REFERENCE TO RELATED APPLICATIONS

This application is related to pending U.S. patent application Ser. No. ______ entitled “SCENARIO-BASED SEARCH”, (Attorney Docket Reference MS316958.01/MSFTP1415US) filed on Jun. 29, 2006. The entirety of the above-noted application is incorporated by reference herein.

### BACKGROUND

Search engines agents, often referred to as spiders or crawlers, navigate websites in a methodical manner and retrieve information about sites visited. For example, a crawler can make a copy of all or a portion of websites and related information. The search engine then analyzes the content captured by one or more crawlers to determine how a page will be indexed. Some engines will index all words on a website while others may only index terms associated with particular tags such as such for example: title, header or metatag(s). Crawlers must also periodically revisit webpages to detect and capture changes thereto since the last indexing.

Once indexes are generated, they typically are assigned a ranking with respect to certain keywords, and stored in a database. A proprietary algorithm is often employed to evaluate the index for relevancy, for example, based on frequency and location of words on a webpage, among other things. A distinctive factor in performance amongst conventional search engines is the ranking algorithm respectively employed.

Upon entry of one or more keywords as a search query, the search engine retrieves indexed information that matches the query from the database, generates a snippet of text associated with each of the matching sites and displays the results to a user. The user can thereafter scroll through a plurality of returned sites in connection with determining if the sites are related to interests of the user.

However, scrolling through results can be an extremely time-consuming and frustrating process as search engines often return a substantial number of sites. More often then not, the user is forced to further narrow the search iteratively by altering and/or adding keywords and Boolean operators to converge on websites that provide the sought after information.

### SUMMARY

The innovation disclosed and claimed herein, in one aspect thereof, comprises a system and/or methodology that infers and/or determines a goal of a user (e.g., based upon a variety of factors). Once the goal (e.g., intent, objective) is established, the system can proactively effectuate a computer search in accordance with the goal thereafter automatically initiating an action based upon a subset of results of the search. By way of example, the system can monitor a user's context and state thereafter dynamically journaling and logging criterion by which the user's objective(s) can be established. Effectively, the innovation provides for a search to become an action that has direct nexus to an inferred (or determined) goal of an individual.

More particularly, in accordance with an exemplary embodiment, extrinsic information relating to a user is dynamically received and analyzed in connection with inferring a goal of the user. Inferred user goal information is employed to perform dynamic Internet-based searches corresponding to the inferred user goal—search results are dynamically cached and updated. Based upon a current user state, a subset of the cached search results are displayed to the user as a function of a utility-based analysis that factors cost, associated with displaying content to the user not of interest versus benefit of displaying desired content. Further, the subset of cached search results can be employed to automatically effectuate an action that related to the inferred user goal.

In another aspect of the innovation, the system can pre-fetch information and selectively display the information to the user to facilitate achieving a goal. In still another aspect, the innovation can be employed to modify existing personal information manager (PIM) data based upon learned (or inferred) information. Still further, metadata related to a location(s) and item(s) can be employed to facilitate such objective-related computer searching.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and features of the innovation will become apparent from the following detailed description of the innovation when considered in conjunction with the drawings.

### BRIEF DESCRIPTION OF THE DRAWINGS

FIG. 1 illustrates a system that facilitates analyzing a user objective to establish a search in accordance with an aspect of the innovation.

FIG. 2 illustrates an exemplary flow chart of procedures for inferring a goal and effectuating a search in accordance with an aspect of the innovation.

FIG. 3 illustrates an exemplary flow chart of procedures for determining an intent of a user with respect to a search in accordance with an aspect of the innovation.

FIG. 4 illustrates an exemplary flow chart of procedures for automatically gathering information in order to determine a user intent in accordance with an aspect of the innovation.

FIG. 5 illustrates an exemplary system that facilitates generating an objective, conducting a search and configuring results in accordance with an aspect of the innovation.

FIG. 6 illustrates an exemplary architecture of a user objective generation component in accordance with an aspect of the innovation.

FIG. 7 illustrates an exemplary set of information sources that can be accessed or can provide information to a user objective generation component in accordance with an aspect of the innovation.

FIG. 8 illustrates an exemplary monitoring component that can automatically document a journal or a log related to context/state factors in accordance with an aspect of the innovation.

FIG. 9 illustrates an architecture including an artificial intelligence-based component that can automate functionality in accordance with an aspect of the innovation.

FIG. 10 illustrates a block diagram of a computer operable to execute the disclosed architecture.

FIG. 11 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

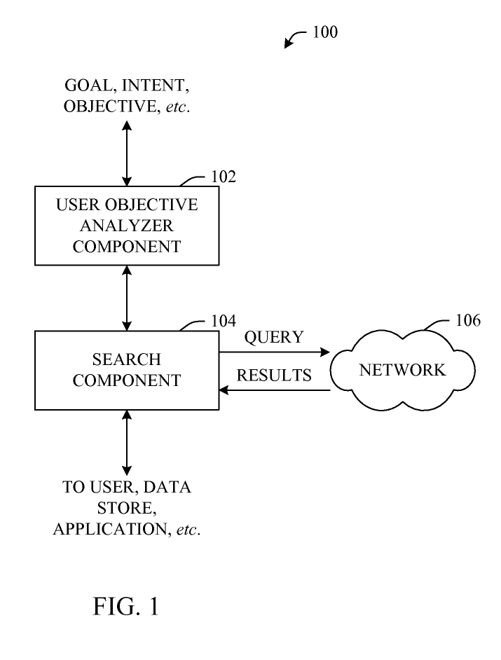

Referring initially to the drawings, FIG. 1 illustrates a system 100 that can provide for an information search to become or prompt a proactive action having a direct nexus to an inferred or determined goal of an individual or group of individuals. Generally, system 100 can include a user objective analyzer component 102 and a search component 104. Each of these components (102, 104) can be employed to effectuate an information search based upon a goal, intent or objective of a user. The user objective analyzer component 102 can evaluate a user goal, intent objective, etc. and thereafter communicate with the search component 104 which can translate a determined and/or inferred goal into an action via information search. As shown, in one aspect, the search component 104 can communicate via network 106 to identify information relevant to the goal or intent. It is to be understood that the network 106 can be representative of the Internet, intranet, multiple networks, multiple servers, or the like.

Further as illustrated in FIG. 1, the user objective analyzer component 102 can receive a predefined and/or inferred goal. It will be understood upon review of the figures that follow the goal can be inferred or determined by monitoring and interrogating a variety of information sources. By way of example, a user personal information management (PIM) data component (not shown) can be interrogated by which a goal can be inferred or predicted. It will be appreciated that degree of certainty and/or accuracy can be affected by accuracy of the PIM data. As well, the accuracy can be affected by combining additional information, for example historical user logs, together with the PIM data. In other words, the reliability of the inference can be increased by considering more data points within the determination of the user goal. The inference can be accomplished via probabilistic and/or statistical techniques. Moreover, a utility-based analysis can be applied that factors cost of making an incorrect inference against the benefits associated with a correct inference. Confidence levels can also be employed and adjusted as a function of criticality of the goal and means employed to accomplish the goal.

Referring again to FIG. 1, once the search component 104 queries and receives results from the network 106, the results can be rendered to a user, application, etc. As will be described in greater detail infra, the results rendered from the search component 104 can be displayed to a user or alternatively, stored in a data store, or supplied as an input to an application. As well, the results can be configured in accordance with the goal and/or a defined context.

In another aspect, the results can be maintained in a data store or other storage device (e.g., cache, memory). By way of specific example, the search can prompt modification of a calendar entry within a user's PIM data. In this scenario, the system 100 can automatically update the PIM data with the results from the search component 104. As well, the search results can be stored and subsequently used to train the system thereby effectuating an increase in intelligence as the system evolves over time.

In yet another embodiment, the system 100 can facilitate inputting search results from the search component 104 into another application. For instance, the search component 104 can be employed to return a number of venues (e.g., restaurants, night clubs) in response to a query. As such, the search component 102 can be employed to automatically prompt an action such as inputting this information into a mapping product which can automatically generate directions to the alternate venue. Still further, the system 100 can automatically rank and/or render results based upon a learned user preference.

The search component 104 can further prompt an action by automatically communicating with an application in order to generate future actions, appointments, reminders, tasks or the like. By way of specific example, the search component 104 can be employed when a user is planning a vacation and would like to schedule an event (e.g., a Broadway show). In this example, the search component 104 can be employed to return show times based upon a result from the user objective analyzer component 102. It will be understood that the user objective analyzer component 102 can interrogate a user schedule (e.g., PIM data) thereafter determining the best time(s) to attend a show with respect to the available show schedule.

Accordingly, the search component 104 can automatically obtain show information thereafter prompting automatic purchase of tickets and population of the user calendar with the show time. It will be understood that the scenarios described herein are provided to add perspective to the innovation and are not intended to limit the innovation in any way. Moreover, it will be understood that other scenarios exist and are to be included within the scope of this disclosure and claims appended hereto.

In another example, suppose that a user's automobile is equipped with the functionality of the subject invention on its on-board computer, having Internet and global positioning system (GPS) access. In accordance with this scenario, search can be dynamically conducted while the user is driving, and if a determination is made that the user context/state is near dinner time, user is inferred to be hungry and prefers a specific type of food (e.g., sushi), the search system 100 can automatically perform searches for the specific type of restaurant (without user prompting). Further, the system 100 can synchronize and/or communicate with the GPS which would automatically provide directions to the nearest desired restaurant. In other aspects, the system 100 can weave the dynamic search into automated action implemented by other devices (e.g., cell phones making a purchase, a translated greeting occurring, a security system tuning level of inspection based on a dynamic background search, etc.

In another embodiment, a personal data assistant (PDA) can dynamically gather extrinsic information related to a user (e.g., location, what the user is looking at, reading, activity engaged in, velocity, etc.) and dynamically execute search queries based on such extrinsic information and cache corresponding search results for potential display to the user. For example, if the user is grocery shopping the analyzer component 102 can provide information relating to specific store, location of user (e.g., by vegetable section). The search component 104 can perform searches based on such information and cache corresponding search results—results relating to fair prices for produce, nutritional content, etc. can be cached so that when the user views the PDA for vitamin content in tomatoes versus spinach the information is already available for display or even already displayed based upon an inference that this was the information inferred to be desired by the user. It is to be appreciated that the cached data can be dynamically aged out or updated as a function of, for example, available memory and changing user state.

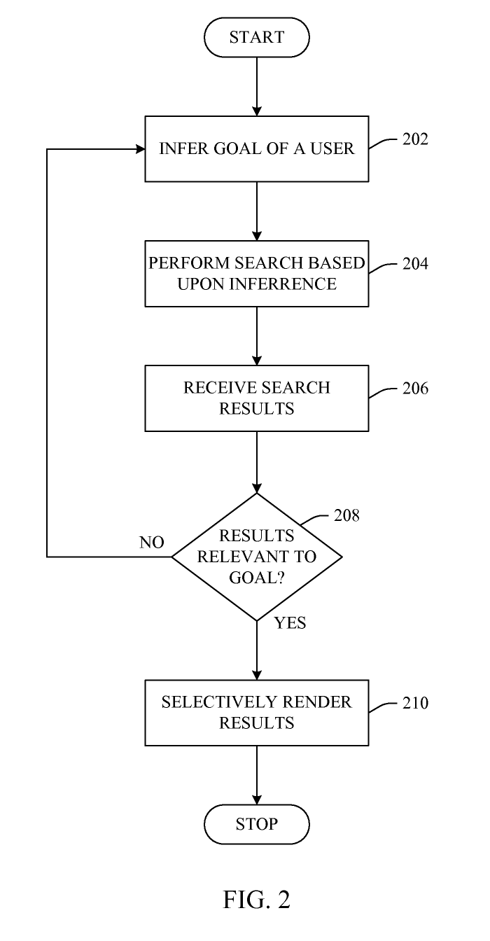

FIG. 2 illustrates a methodology of effectuating a search in response to a determined or inferred user goal in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a user goal can be inferred. Alternatively, the user goal can be directly entered by a user. Still further, the system can interactively interrogate a user in order to determine an objective or goal. Once the goal is determined, a search can be proactively performed in accordance with the determined and/or inferred objective. Search results in accordance to the goal can be obtained and/or received at 206. Once received, at 208, a determination can be made to conclude if the results are relevant to the user goal. If the results are not deemed to be relevant to the goal, the methodology can return to 204 where aspects of the goal can be further inferred as shown. On the other hand, if it is determined that the results are relevant to the goal, the results can be selectively rendered at 210.

By way of more specific example, the results can be configured, ranked, filtered, etc. based upon the goal. Further, as described with reference to FIG. 1, the search results can be employed to automatically an action associated with the user goal. Still other aspects can consider a user context, e.g., location, state, etc. when determining an appropriate rendering mechanism and/or manner.

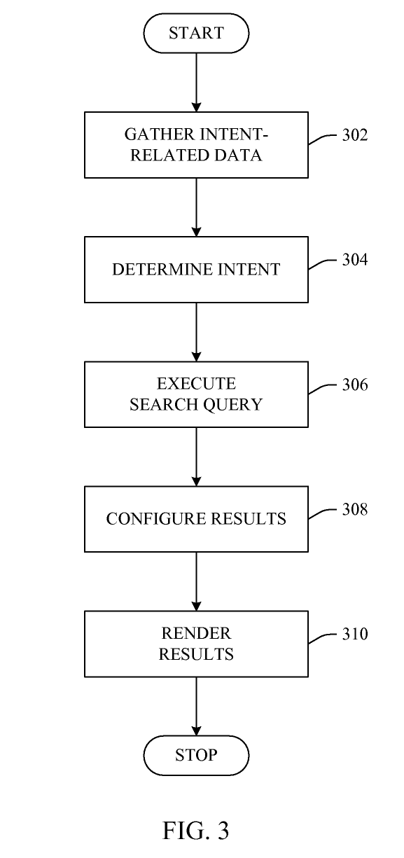

FIG. 3 illustrates an exemplary methodology of an aspect of the innovation that effectuates establishing an objective and configuring results in accordance with the objective or intent. At 302, intent-related data can be gathered thus effectuating an act of determining an intent. For example, the innovation can consider a number of factors, for example, travel preparation actions, Internet search topics, schedule items, etc. thereafter inferring or determining a user intent. As will be described with reference to the figures that follow, substantially any input and/or context factors can be employed in order to determine or infer a user intent (e.g., objective, goal) in accordance with aspects of the innovation.

Once the intent is determined, at 306, a proactive information search can be commenced based upon the intent and/or objective. This information search can obtain information from effectively any available source, including but not limited to the Internet, intranet(s), local and external data stores, etc. As well, it is to be understood that information can be gathered from multiple sources in accordance with a single user intent.

At 308, the results of the search and/or information gathering process can be configured with respect to the intent. As well, the results can be configured in accordance with the user context/state. Once configured, the results can be rendered at 310. By way of example and not limitation, the results can be filtered, sorted, ranked, arranged, etc. in order to complement a user intent by rendering meaningful results. As well, the results can be rendered to an application or other store that compliments the user intent. For instance, the information can be automatically inserted into a user PIM data or other scheduling and/or tracking application.

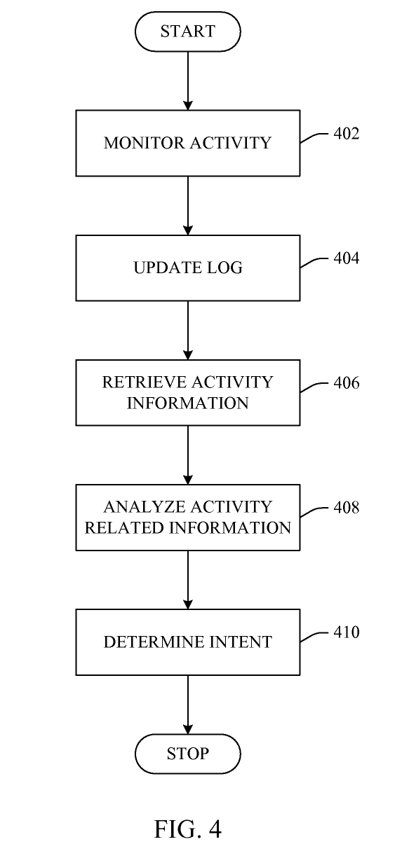

Referring now to FIG. 4, a methodology of tracking a user's action(s) and state in order to determine or infer an intent is shown in accordance with an aspect of the innovation. At 402, activity (e.g., action(s), state, context) is monitored with respect to a user and/or device. By way of example, user activity with regard to places visited, websites accessed, applications used, etc. can be monitored. This activity and/or context information can be logged at 404. More particularly, this information can be logged into a local and/or remote data store (or other storage device (e.g., cache, buffer)) in accordance with aspects of the innovation.

The stored information can be retrieved at 406 and analyzed at 408. Thereafter, a user intent (e.g., objective, goal) can be determined or inferred at 410. This intent can be determined based upon the state and context data monitored at 402. It is to be understood that the ability to determine and/or infer a user intent is a feature of the innovation. As well, the ability to automatically, and/or dynamically, with respect to changes in intent, execute a search is another aspect of the innovation. Moreover, the ability to selectively configure and/or render the intent-based search results is still another feature of the innovation. Each of these features will be described in greater detail infra.

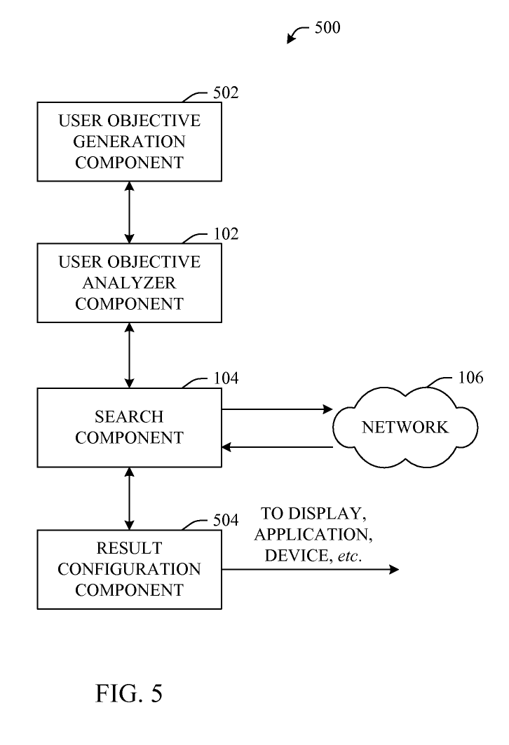

Illustrated in FIG. 5 is an alternative system 500 that facilitates executing an objective-based search in accordance with the features of the innovation. More particularly, in addition to the user objective analyzer component 102 and the search component 104 of FIG. 1, the system 500 includes a user objective generation component 502 and a results configuration component 504. The user objective generation component 502 can be employed to determine or infer a user objective, intent and/or goal with reference to accessed, monitored or received factors. For example, as described with reference to FIG. 4 above, user objective generation component 502 can enable the system 500 to monitor, log and retrieve user state and/or context information from which an objective can be determined or inferred.

Similarly, as described with reference to the methodology of FIG. 3, the result configuration component 504 can be employed to configure the search results in accordance with the user intent. This result configuration component 504 can enable the system 500 to selectively render the search results. The results can be rendered to a display, application or disparate device. This selective rendering enables the innovation to proactively act upon an intent by providing meaningful search results and/or subsequent actions based upon the meaningful search results.

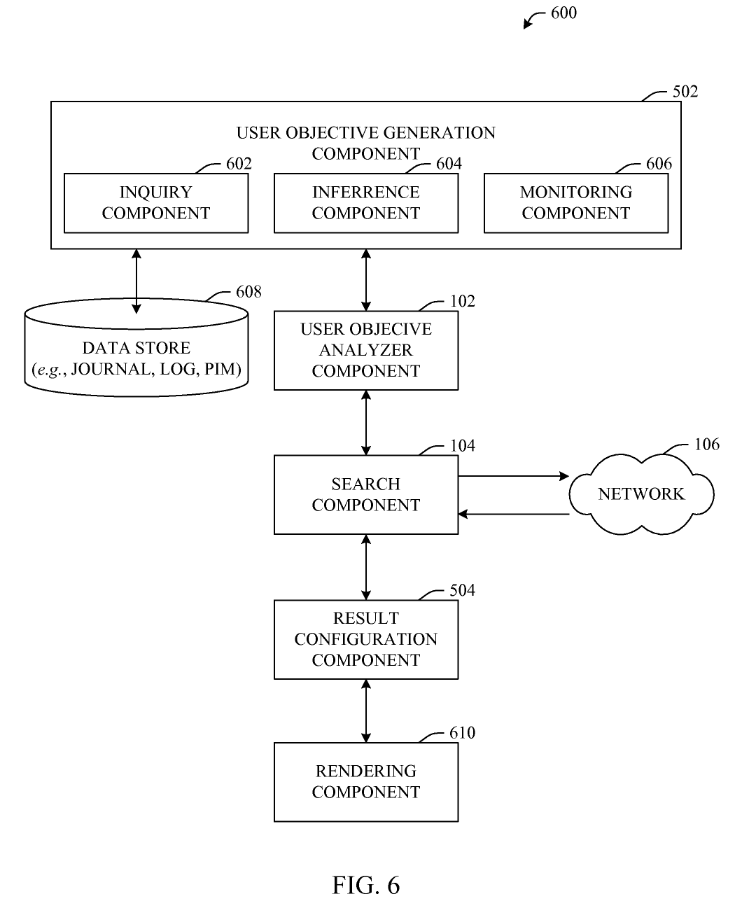

Turning now to FIG. 6, an alternative system 600 that facilitates proactively obtaining intent-based search results in accordance with an aspect of the innovation is shown. As illustrated, user intent generation component 502 can include an inquiry component 602, a monitoring component 604 and an inference component 606. Each of these components, separately or in combination, can be employed to generate a user intent which can be input to the user intent analyzer component 102. As described above with reference to FIG. 1, the user intent analyzer component 102 can be employed to establish a search criteria from the user intent.

Each of the sub-components (602, 604, 606) of the user intent generation component 502 can interact with the data source component 608 to facilitate establishment of a user intent. More particularly, data source component 608 can include user-specific information, including but not limited to journal information, activity/state logs, PIM data as well as customer relations management (CRM) data. This information can be employed to facilitate generation of a user intent.

The inquiry component 602 can effectively interrogate a user to obtain objective-related information. This information can be stored to establish or supplement data maintained within the data store 608. By way of example, the system 600 can infer from user actions and/or state that the user is planning a trip. To this end, in one aspect, the system 600 can ask the user if the trip is for business or pleasure. This information can be utilized by the inference component 604 to establish (e.g., infer) the objective thereafter rendering meaningful search results. By way of more specific example, suppose the trip was a pleasure trip, as such the system 600 can combine this information with other user-related information to obtain search results such as must-see sights, sports events, bike trails, etc. that might be of interest to a user on a pleasure vacation. Similarly, suppose the trip was a business trip, in this scenario the system 600 can be employed to render results that might be helpful to a business traveler such as restaurants, directions to potential client locations (established in part with respect to CRM data), Wi-Fi equipped locations, etc. Each of these scenarios can be based upon the user objective supplemented by information received via the inquiry component 602.

Similar to the inquiry component 602, the monitoring component 606 can be employed to monitor a user's actions, activities, state, location, etc. This user information can be automatically maintained within the data store 608 and thereafter used to facilitate determination of a user intent or objective. Although data store 608 is illustrated as a single storage location, it is to be understood that multiple data storage and source locations can be employed without departing from the spirit and scope of this disclosure and claims appended hereto. As well, it is to be understood that the data sources can be local or remote from each other as well as from the other components illustrated in FIG. 6.

Finally, the rendering component 610 of FIG. 6 can facilitate transfer of the search results to a display, application, alternative device, data store, etc. with respect to the user objective thereby automatically prompting for an action as a function of the search results. For example, if the user is planning a business trip, the rendering component 610 can facilitate automatically contacting a favorite restaurant to make a reservation, booking a hotel reservation, etc. in accordance with a user objective. It will be understood that the scenarios are countless by which the rendering component 610 can employ the intent-related search results in order to automate action. As such, it is to be appreciated that each of these scenarios are to be included within the scope of this innovation and claims appended hereto.

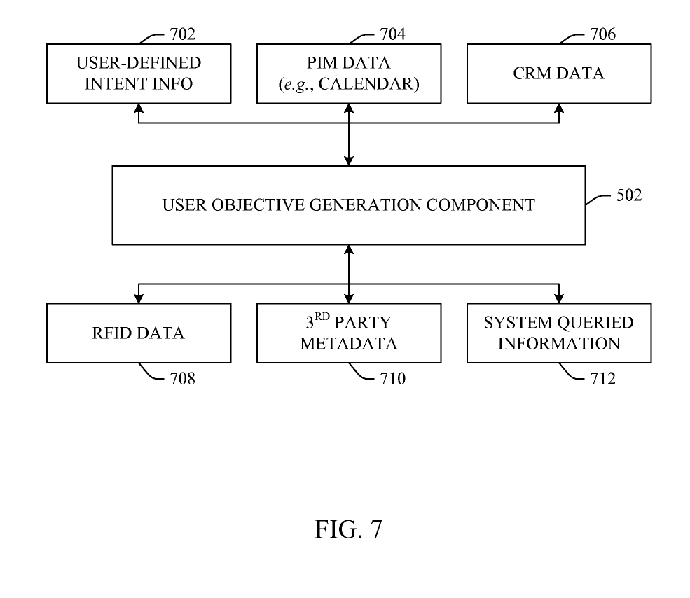

To provide perspective to the functionality of the user intent generation component 502, FIG. 7 illustrates an exemplary set of information sources by which information can be accessed or retrieved in connection with establishing a user intent. As shown, the exemplary set of information sources can include a user-defined intent information source 702, a PIM data source 704, a CRM data source 706, an RFID data source 708, a 3^{rd}-party metadata source 710 and a wizard or system query information source 712. As described above, although specific data sources are shown in FIG. 7, it is to be understood that, in accordance with alternative aspects of the innovation, other information sources can be employed to assist in the establishment of a user objective, goal, intent, etc.

Referring first to the user-defined intent information component 702, this component is representative of a user directly inputting an objective or intent into the system by which an intent-based search can be conducted. In another aspect, PIM data 704 can be analyzed in order to determine the intent. For example, a user's appointment calendar, schedule and/or task list can be employed solely (or to contribute) to establish a user intent. Similarly, a CRM data component 706 can be employed to contribute to establishing a goal. By way of example, specific customer-related information, e.g., ongoing project information, likes, dislikes, location, etc. can be employed to supplement establishment of an objective and subsequent meaningful intent based search.

Still further, RFID data 708 and/or 3^{rd}-party metadata 712 can be employed to facilitate establishment of the user objective and subsequently a set of intent-based search results. For example, RFID and metadata can be employed to enable the innovative system to detect people, places, etc. that can contribute to establishment and analysis of a user objective and/or intent.

In yet another aspect, the system queried information 710 can be employed to determine an intent or analysis thereof. In one example, this system queried information 710 can be obtained via a wizard having templates that can interrogate a user thereby gathering information necessary to identify an intent or goal.

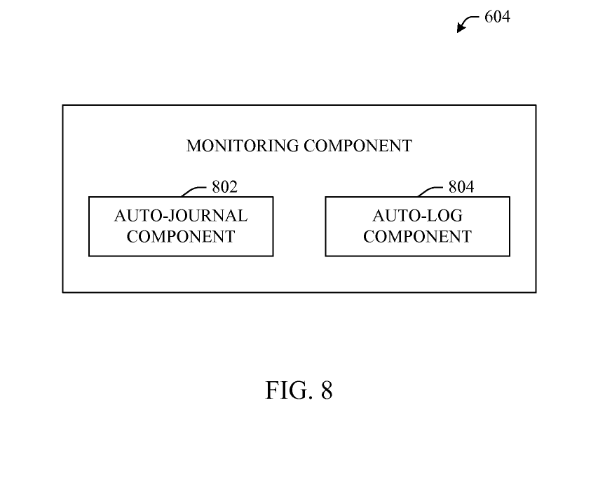

Turning now to FIG. 8, a block diagram of an exemplary monitoring component 604 is shown. In particular, the exemplary monitoring component 604 can include an auto-journal component 802 that can effectively establish an overall journal or diary of a user's actions. Similarly, the exemplary monitoring component 604 can include an auto-log component 804 that can dynamically store (e.g., buffer, cache) data related to places visited, individuals contacted, phone numbers called, etc. Effectively, the monitoring component 604 can be utilized to establish user-specific information by which an intent, goal or objective can be determined. In summary, the innovation can enable a specific goal of a user to be inferred or determined. In accordance therewith, a computer-based search can be automatically performed based upon such inference. Effectively, the innovation provides for the search to become an action that has direct nexus to an inferred goal of an individual.

For example, in accordance with an embodiment of the innovation, a user objective generation component 502 can infer with a high degree of confidence that a user is in need of immediate medical attention. As such, the user objective analyzer component 102 can be employed to define search criterion by which a search can be automatically performed in connection with this need/goal. More specifically, in this example, the search can be employed to automatically, and dynamically, find the nearest hospital as well as to prompt an action such as finding the quickest route given current traffic conditions and weather. This information can be pre-fetched and selectively displayed (or input into another application or device) to the user to facilitate achieving his/her goal.

By way of another example scenario, suppose a user is on a date and dinner is just about finished, here, the user objective determination component 502 can infer that the user is on a first date and wants to make an especially good impression. As such, the system can proactively perform a search to locate a nearby venue (e.g., theatre, pub, concert hall) that will have little commute and wait time so as to crate a smooth seamless evening. Moreover, the system can interact with a GPS or other mapping mechanism (e.g., mapping websites) in order to determine directions to the alternate venue from a current location.

As described above, 3^{rd}-party metadata can be employed to effectuate determination of a subset of this information. For example, venues can establish meta-data that identify current wait times, etc. Moreover, the system can facilitate (e.g., via the rendering component 610) a change in pre-made plans based upon learned information. In one specific example, the system can analyze the presence of a traffic jam up town and determine that it will not be possible to make the start of the opera. Therefore, the system can recommend moving the evening to a local grill just around the corner—there is a live jazz band there this evening and no wait. As noted supra, 3^{rd}-party metadata about the location and items can be employed to facilitate intelligent searching.

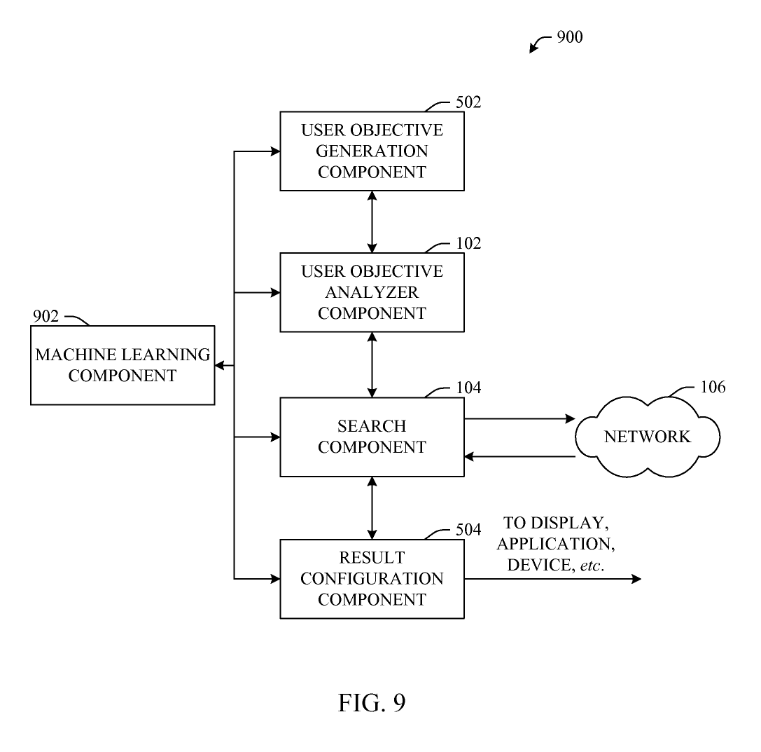

FIG. 9 illustrates a system 900 that employs a machine learning and reasoning component 902 which facilitates automating one or more features in accordance with the subject innovation. The subject innovation (e.g., in connection with inferring a goal, objective or intent) can employ various automated learning and reasoning schemes for carrying out various aspects thereof. For example, a process for determining a current and/or future intent can be facilitated via an automatic classifier system and process.

A classifier is a function that maps an input attribute vector, x=(x1, x2, x3, x4, xn), to a confidence that the input belongs to a class, that is, f(x) =confidence(class). Such classification can employ a probabilistic and/or statistical-based analysis (e.g., factoring into the analysis utilities and costs) to infer an action that a user desires to be automatically performed or to infer a user-specific attribute (e.g., intent, goal, objective).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria what is a user's current intention or goal, what is a user's future intention, what would be a user's future intention based if specific actions occur or factors are present.

Scenarios can be identified with certainty. Alternately, a probability distribution over scenarios may be inferred from streams of evidence. Methods for handling specific scenarios under certainty can be generalized via considerations of expectation and computation of ideal results for browsing, displaying, or alerting based on the use of methods that maximize the expected utility of people based on a consideration of the preferences of the person or persons being supported, and on the uncertainties at hand.

The retrieval and ranking methodologies can be custom-tailored for different scenarios and information goals. In some cases, the outputs of mixtures of methods may be combined in different ways depending on the scenario sensed under certainty or inferred under uncertainty. Such custom-tailored methods can be trained with data collected explicitly or implicitly for specific scenarios.

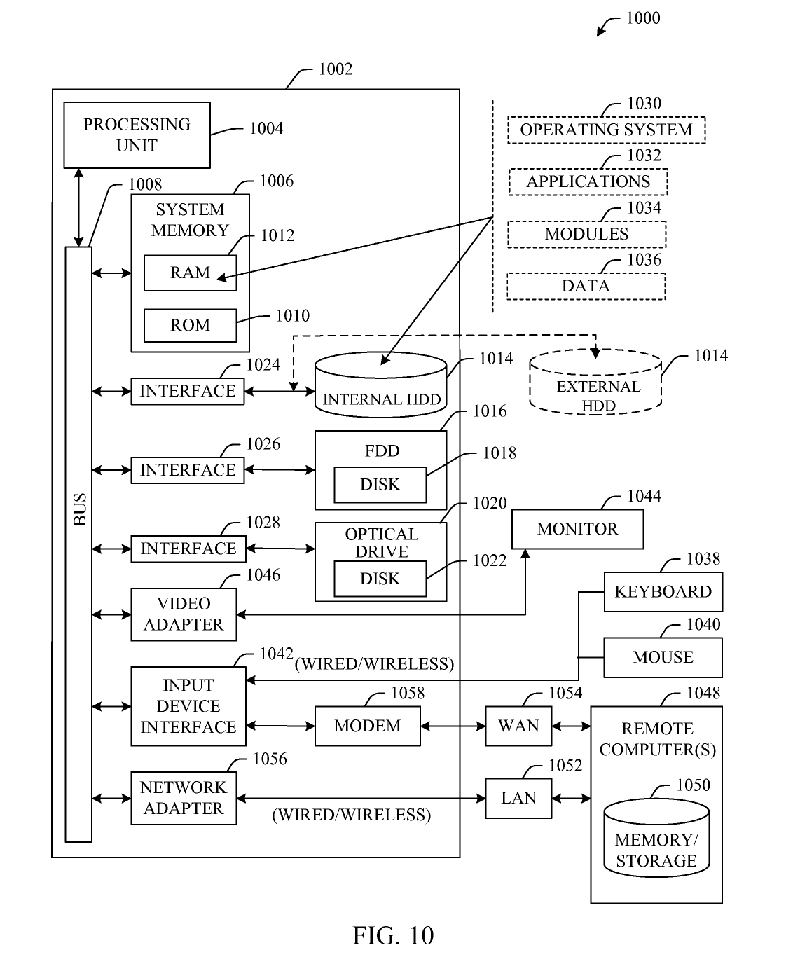

Referring now to FIG. 10, there is illustrated a block diagram of a computer operable to execute the disclosed architecture of prompting a scenario based search. In order to provide additional context for various aspects of the subject innovation, FIG. 10 and the following discussion are intended to provide a brief, general description of a suitable computing environment 1000 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

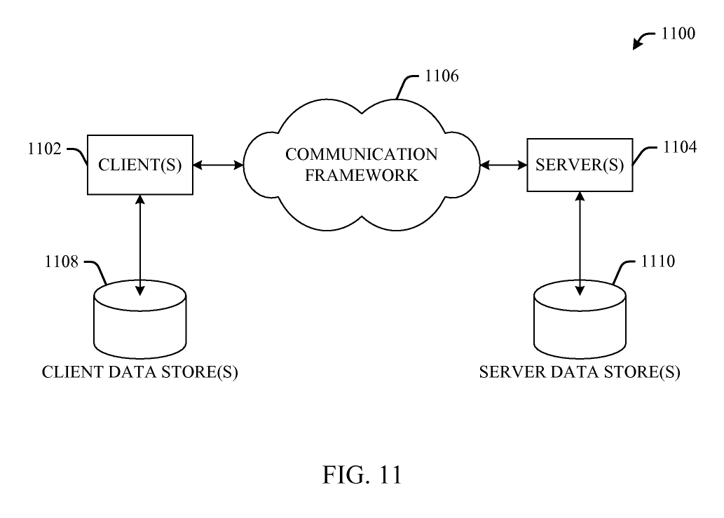

Referring now to FIG. 11, there is illustrated a schematic block diagram of an exemplary computing environment 1100 in accordance with the subject innovation. The system 1100 includes one or more client(s) 1102. The client(s) 1102 can be hardware and/or software (e.g., threads, processes, computing devices). The client(s) 1102 can house cookie(s) and/or associated contextual information by employing the innovation, for example.

The system 1100 also includes one or more server(s) 1104. The server(s) 1104 can also be hardware and/or software (e.g., threads, processes, computing devices). The servers 1104 can house threads to perform transformations by employing the innovation, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates computer-based search, comprising:
a user objective analyzer component that analyzes extrinsic information related to a user and infers or determines a goal of the user; and
a search component that executes a scenario-based computer search as a function of the inferred or determined user goal and automatically prompts an action based upon a result of the computer search.

2. The system of claim 1, the scenario-based computer search yields a plurality of search results based at least in part upon the inferred or determined user goal.

3. The system of claim 2, further comprising a user objective generation component that generates user goal-related information based upon user context and state information.

4. The system of claim 2, further comprising a user objective generation component that infers the user goal based upon information received from a plurality of scenario-related data sources.

5. The system of claim 4, the plurality of scenario-related data sources includes at least one of user-defined intent information, personal information management (PIM) data, customer relations management (CRM) data, radio frequency identification (RFID) data, 3^{rd}-party metadata and/or system generated metadata.

6. The system of claim 2, further comprising a result configuration component that manages the plurality of search results in accordance with the inferred or determined user goal.

7. The system of claim 6, the result configuration component at least one of filters, ranks and orders a subset of the plurality of search results.

8. The system of claim 1, the user objective analyzer component employs a probabilistic-based utility analysis in connection with factoring cost of an incorrect inference as to user goal versus benefit associated with a correct inference.

9. The system of claim 1, further comprising a user objective generation component that establishes the goal-related information based upon user context and state information.

10. The system of claim 9, the user objective generation component further comprises an inquiry component that queries a user to determine user context and state information.

11. The system of claim 9, the user objective generation component further comprises an inference component that applies a reasoning-based analysis to infer user context and state information.

12. The system of claim 11, further comprising a machine learning component that employs at least one of a probabilistic and a statistical-based analysis to establish the user context and state information.

13. The system of claim 9, the user objective generation component further comprises a monitoring component that observers a user to establish a subset of the user context and state information.

14. The system of claim 13, the monitoring component includes an auto-journal component that dynamically records a plurality of actions related to the context and state information of the user.

15. The system of claim 13, the monitoring component includes an auto-log component that dynamically records the context and state information related to the user.

16. A computer-implemented method of establishing a goal-related computer-based search, comprising:
dynamically analyzing extrinsic information related to a user;
dynamically inferring an intended goal of the user as a function of the analyzed extrinsic information;
dynamically executing search queries based on the inferred user goal;
dynamically caching and updating the search results; and
automatically prompting for an action as a function of a subset of the search results.

17. The method of claim 16, further comprising dynamically displaying a subset of the cached search results to the user based upon a utility-based analysis in connection with content inferred to be desired for current viewing by the user.

18. The method of claim 17, further comprising monitoring a plurality of context and state factors related to the user.

19. A computer-executable system that facilitates an objective-based computer search, comprising:
means for determining an objective of a user from a plurality of context/state factors;
means for identifying a plurality of search criteria based at least in part upon the objective;
means for executing a search based at least in part upon a subset of the plurality of search criteria; and
means for initiating an action based upon a result set of the search.

20. The computer-executable system of claim 19, the means for determining the objective comprises at least one of querying the user to identify a subset of the plurality of the context/state factors, means for inferring a subset of the plurality of the context/state factors from a history of actions of the user, and means for monitoring the user to determine a subset of the plurality of the context/state factors.
